(19) United States
(12) Patent Application Publication
(10) Pub. No.: US 2016/0307040 A1
(43) Pub. Date: Oct. 20, 2016

(54) Systems and Methods of Using Labels for Evaluation of Produce and Other Foods

(71) Applicant: Alan Shulman, Santa Rosa, CA (US)

(72) Inventor: Alan Shulman, Santa Rosa, CA (US)

(21) Appl. No.: 15/191,531

(22) Filed: Jun. 24, 2016

Related U.S. Application Data
(63) Continuation-in-part of application No. 14/563,965, filed on Dec. 8, 2014.
Application No. 14/563,965 is a continuation-in-part of application No. 14/135,363, filed on Dec. 19, 2013.
(60) Provisional application No. 61/739,357, filed on Dec. 19, 2012.

(51) Int. Cl. G06K 9/00; G06T 7/40

(52) U.S. Cl. CPC G06K 9/00657; G06T 7/408; G06T 2207/10024; G06T 2207/30188

(57) ABSTRACT

Attributes of vegetables or biologics are derived by use of color imaging sensors and relative spectral band analysis. Enabled smart phones or dedicated single pixel or focal plane instruments for crop applications to quickly report the biological condition of vegetables or other organics by providing an augmented view or relative quantification of RGB ratios of the inspected items. The RGB ratios are compared to RGB ratios of preprinted labels. The comparison yields information regarding the freshness and other attributes of the inspected item. Disclosed embodiments are well suited for analyzing the health and needs of living plants or crops. Ratios of observed wide band red, green and blue are compared on a relative basis. While food shopping, an enabled smart phone may view an agricultural product and use a preprinted RGB ratio label as a reference guide.

### CROSS-REFERENCE TO RELATED APPLICATIONS

This utility application is a continuation in part to U.S. application Ser. No. 14/563,965 filed on Dec. 8, 2014 which is a continuation in part of U.S. application Ser. No. 14/135,363 filed on Dec. 19, 2013; the Ser. No. 14/135,363 application claims the benefit of priority of U.S. Provisional Application 61/739,357 filed Dec. 19, 2012. This utility application additionally claims the benefit and priority of provisional patent application 62/183,639 filed on Jun. 23, 2015. The contents of the related applications are expressly incorporated herein by reference in their entirety.

### BACKGROUND OF THE INVENTION

(1) Field of the Invention

The invention generally relates to color ratio analysis of plant life. More particularly, the invention relates to a novel label or signage system having a ratio test color area used to compare color ratios of plant life to determine organic material qualities.

(2) Description of the Related Art

U.S. Publication 2013/0325346 by McPeek and published on Dec. 5, 2013 discloses a system for observing and monitoring agricultural products. But, McPeek fails to disclose or suggest the use of ratio color analysis to grade or judge agricultural products.

In the related art, food products such as produce, fish and meats are evaluated by touch, smell and viewing with the naked eye. The human eye is limited in its ability to see or evaluate color spectrums, and small differences in specific color ratios may not be discriminated by a human eye. Thus, there is a need in the art to leverage and artfully augment common smartphone and other digital camera technologies to provide a more refined analysis of food products.

In the related art, spectral narrowband measurements using spectrometers have been used to evaluate organic objects. They usually measure a small area that may or may not be representative of the variations in a product and only provide one data point from a small portion of the product. Multispectral technology is much more expensive, but can present multiple data points in context with an image. The expense and complexity have been formidable barriers to widespread use. As plants and vegetables age, some parts change a different rates depending upon position in the plant or vegetable, areas of sunlight and leaf shade and environmental factors. Spectral data must be analyzed in context of the overall image. But, there is a serious shortfall in common visible light camera imaging devices including consumer devices with image sensors, such as smart phones. Electronic cameras are typically burdened with infra-red (I.R.) and or Bayer filters that interfere with measuring narrowband light frequencies. Thus, there is need in the art for new means and methods that eschew the use of narrowband frequencies to analyze agricultural products without removing integral optical components and can use common digital imaging cameras with Bayer filter technologies.

### BRIEF SUMMARY OF THE INVENTION

The present invention overcomes shortfalls in the related art by presenting an unobvious and unique combination, configuration and use of methods and devices using wideband light frequencies and other techniques to find color ratios of subject plant life or food products. A label or other test color or ratio representation can be used to provide reference information that can characterize the desired food quality parameter such as freshness, chlorophyll, photo synthetic sensitivity or nutritional values. The presently disclosed embodiments provide a quick and accurate analysis of agricultural and meat products to quickly and visually report ripeness, health and other critical characteristics.

After an agricultural product has been electronically viewed, or contemporaneously with such a viewing, a wide band spectral analysis may occur, as described herein and may include the generation of ratio values of individual color channels from a Bayer filter. The calculated generated ratio values may be displayed in many forms such as an image of the vegetable combined with a grey scale or pseudo color or an average number or other simplified threshold scales that indicate if grade levels are acceptable or unacceptable. The generated absolute color channel value or color channel ratios may be compared manually, visually or electronically to a preprinted label that embodies the color channel ratios. The preprinted ratio label may take the form of a color, or a series of colors, with the printed colors representing ideal ratios or ratios indicative of desired qualities, such as chlorophyll degradation, nutritional content, freshness, ripeness, stress, hydration states and other variables related to quality.

Wideband relative Bayer filter color channel summations and channel ratios provide advantages over the prior art by accurately reporting agricultural biology such as chlorophyll, photo synthesis rates, carotenoid formation, beta carotene flavonoids and other variables in context with an image on common devices. Extremely effective and informative relative wideband spectral cannel summary ratios may be obtained using wideband channel values obtained from the artful use of wideband Bayer filters. Wideband relative spectral channel ratios provide unexpectedly favorable and accurate results including the use of ratio channels that overcome the ambiguities introduced by Bayer Filters and overlapping spectral bands. The Bayer filter introduces non linear sensitivities within color bands as well as overlaps that creates ambiguities. For example, traditionally blue is defined as 400 to 500 nanometers, green in the range of 500 to 600 nanometers and red is defined in the range of 600 to 700 nanometers. By use of the disclosed systems and methods herein, modified wideband Bayer filter ratio channels are derived by use of values that include overlaps which are not found in the prior RGB based art and also interfere with accurate measurements by creating ambiguities from non linear intensity sensitivity within a band. Unlike traditional rgb approaches with linear sensitivity across a color band, Bayer filters also introduce errors from non linear intensity sensitivities within the respective bands. For example, modified wideband Bayer filter ratio channels may include a blue channel wideband sensitive to frequencies at approximately 420 to 520 nm with a peak sensitivity at approximately 450 nm, a green channel wideband at approximately at 460 to 600 nm with a peak sensitivity at 540 nm and wideband channel red at 570 to 650 nm with a peak sensitivity at 590. Since overlaps and non linear sensitivity compared with the traditional values for red, green and blue would suggest color values that cannot be consistent with traditional RGB values. The use of such disclosed modified Bayer filter channel ratios results in advantages of accurately reporting biological qualities and comporting to the use of common smart phone technology. In some circumstances, offer additional benefits by inferring narrow band values in the overlapping areas.

A supplemental label or signage can improve the results of modified wideband analysis, but are not required. Disclosed embodiments overcome shortfalls in the prior art by the use of modified wideband Bayer wideband spectral cannel summary ratio channel ratios. An enhanced technique can include preprinted labels that may be used to compare wideband Bayer filter RGB ratio channels of a subject agricultural product. The use of the disclosed preprinted labels allows a vendor or supplier to custom tune desired modified wideband Bayer wideband spectral cannel summary ratio channels to comport with a specific species of product that is being offered and can compensate for different ambient light conditions which can alter accuracy. The contemporaneous presentation of a preprinted label minimizes additional confusion that different ambient light conditions introduce and can be used to present characterization of channel ratio values are that are optimal for the evaluation of the subject agricultural product. A vendor may carefully select the optimal channel ratios and present such ratio information upon a preprinted label in the form of a color that reflects the optimal modified wideband Bayer RGB ratio channels so that a food product can be instantly assessed by a consumer using a common electronic camera.

Disclosed embodiments overcome shortfalls in the art by methods and systems can also use narrow bands of ranges of light frequencies to measure specific biological characteristics.

Disclosed system and methods overcome shortfalls in the traditional rgb art such as 390 to 700 nm and non-visible light frequencies.

Disclosed systems and methods overcome shortfalls in the art by considering light level changes and specific intensity sensitivities in overlapping blue and green wideband Bayer channels as well as green and red overlaps after supplemental illumination. By comparing the increase in the blue and green channels after narrow band illumination in the overlap range, accurate measurements may be made of the narrow band frequency of the auxiliary light even though wide bands are being used.

Further advantages over the prior art can also be achieved by the refinement of channel ratios by use of one or more known flash or other illumination source levels, and use of the corresponding channel values for each known light level. Such refinement may be achieved by subtraction techniques combining two or more ambient light, low light and high light values. This will provide absolute modified color channel values in addition to relative values.

Further advantages over the prior art are achieved by the artful acquisition and use of modified Bayer wideband spectral channel summary ratio channels obtained from different parts a single plant, which can provide maturation, senescence, as well as water or fertilizer or disease characterization with or without the use of labels.

Living plants or crops may be viewed by a consumer device and the electronic display may be altered to emphasize attributes relevant to the care of growing plants.

Disclosed embodiments avoid the required narrowband frequencies by several methods and systems which include:

The relationships of modified wide band sum information and comparisons to make relative quality assessments

The use of auxiliary lighting sources, such as flashes and lighting of specific spectral values and intensities.

The use of thermal sensors.

The use of a laser projector device.

The use of image sensors of one or more pixels to produce one or more collections of image data.

The use of image processors to modify wideband spectral channel summary data for display or to use broad spectrum ratios in a step of analysis or to directly augment the display of products.

The calibration of an image processor to comport with the optical character of the particular smart phone being used and lighting conditions.

The determination of weighted coefficients for each modified wideband color channel to enhance the calculation results that are determined by the spectral response of the objects to be measured.

The use of known spectral response of objects in the field of view and resulting wideband color channel sum values.

The use of relative wide band value comparisons of multiple objects in a field of view.

The use of comparisons to known measured characteristics such as color or frequency ratios.

The use of wideband ratios of specific parts of a vegetable or plant for characterization of biologic states. For example, the tip and stem ends of a banana will ripen later, while the middle will usually ripen first.

Disclosed embodiments include the use and display of color ratios and calculations or measurement of absorbance and reflection of color bands or ranges of light frequencies. Disclosed systems and methods use the described wideband technology and include means and methods of assisting and compensation for variables such as lighting, technical spectral camera sensitivities and response. Disclosed systems and methods may use a camera flash as an augmented light source or other supplemental light source that is used to improve the discovery of color ratios.

Disclosed embodiments include the analysis and creation of predetermined or preprinted color test areas. The predetermined or preprinted color test areas are sometimes referred to herein as labels. A preprinted color test area may also be referred to as a preprinted color test ratio, as a preprinted label may comprise colors derived from color ratios. These color areas are different than calibration charts used to calibrate cameras.

The disclosed use of wideband systems herein allows existing smartphones or other digital imaging devices to be augmented or otherwise modified or used to create or discover the color ratios used to compare with the color ratios of the preprinted color test areas.

Disclosed embodiments include the evaluation and identification of the best produce with the highest measurements of chlorophyll or highest photosynthesis sensitivity. Multiple ratios and formulas are indicative of multiple kinds of useful properties and characterizations.

Disclosed embodiments overcome shortfalls in the art as the prior art may require lengthy periods of time to analyze organic material. The disclosed embodiments provide a quick analysis of ratio information and a quick comparison to color ratios presented in the preprinted color test areas.

Disclosed embodiments include preprinted color ratio areas or ratio labels that may optionally include areas for white balance or optionally camera color calibration. Disclosed preprinted color ratio areas or ratio labels may be presented as obvious or may be hidden or camouflaged in a logo, text or background image of the label. Disclosed preprinted color ratio areas or ratio labels may be affixed to a subject organic product, its packaging or placed as signage or upon signage adjacent to a subject organic product. A view through the label or adjacent will enable the comparison of the ratios in the label area to the actual product.

Disclosed systems and methods include a machine vision comparison of ratios of a subject organic product and preprinted color ratio area. The comparison may be made by grayscale or by imaging processing techniques. Ratio information of a subject organic product may be gathered on a segmented basis, wherein a plurality of product areas are analyzed or measured for color ratios. A preprinted color ratio label may comprise a plurality of segmented color areas. These features overcome shortfalls in the art as segmented ratio gathering and segmented ratio labels allow for a plurality of variables to be measured and analyzed. For example, measuring an organic product in one area may be a good indication of hydration and a ratio label may include a specific ratio segment mapped to hydration.

### Embodiments Features and Overview

Inefficiencies in the prior art are overcome by the streamlined image processing of wideband spectral channel summary data to directly derive ratio findings. Unexpected results and efficiencies have been obtained using subtraction techniques with auxiliary lighting such as a camera flash or narrow band lighting quickly derive color ratios of a subject organic product.

Inefficiencies in the prior art are overcome by directly altering the display of a product to be evaluated by use of gray scale and pseudo images that represent calculated ratios. Disclosed embodiments overcome the shortfall of Bayer filters, IR filters and other obfuscations of narrowband spectrometers by utilizing wideband spectral channel summary data.

values from the digital output and manipulating the separation of colors by methods described herein. The artful separation of colors as disclosed herein is useful in finding the ratios of such colors in a subject organic product.

In general, disclosed embodiments use wideband Bayer color channels designated as red blue and green wideband spectral channel summaries in place of pure or absolute values of traditional RGB approaches. Methods include comparisons of multiple segments of a subject organic product displayed in an enhanced single image. Methods include the creation and display of color or color patch, derived from the ratios of measured wideband color channels using the disclosed wideband systems.

Disclosed systems and embodiments include the use of optional enhanced lighting to improve results or to enable methods of image processing including subtraction. Disclosed systems and embodiments include image processors enabled to create images or augment images based upon wideband spectral channel summary ratios and/or previously researched formulas. The modified derivative formulas have been transformed for wideband calculations using the described methods and systems herein. Created or augmented images may be displayed in grey scale of pseudo color for dramatic effect and/or further enhanced to show desired ratios and/or reflect comparisons to preprinted color ratio areas.

Disclosed systems and methods include the use of creating or augmenting images in pseudo color or grey scale correlated to the analysis. Such methods include separating color and grey scale components of the original image and compositing new images that embody the calculated ratios.

Disclosed system components include wideband sensors, such as those native to current smartphones and digital cameras, memory for image storage, image processors used to execute machine readable instructions to implement the disclosed methods, auxiliary lighting, methods to trigger auxiliary lighting and look up tables to compensate for smartphone or other device characteristics or for analytic comparisons of light reflection properties of a photographed subject organic product.

In a disclosed embodiment, in the evaluation of a subject organic product such as a tomato, the color ratios of wideband red to wideband green are found and used to determine ripeness. A preprinted color ratio area may comprise a printed color, with the printed color at a light frequency derived from an optimal red to green ratio.

Alternative embodiments include the use or integration of color filters within or upon a ratio label to facilitate wide or narrow band color analytics such that a product to label comparison may occur by eye, or electronically with a sensor and processor. The filters may be small, can be multilayered film or filter dyes and may be a component of the label or based on quantum dot technology. Ratio labels with integrated color spectral filters may be constructed so that light is reflected by the vegetable or product surface, and a specific spectral band or bands can be used for calculations.

Alternative embodiments include methods and systems to create test ratio labels wherein photos are recorded and archived for comparative purposes of a subject organic product in the product's best state or in a known condition. Known conditions may include a number of days post-harvest or a disease state caused by mold or iron deficiency. Label reference pictures may be taken with normal flash, auxiliary spectral light source and or led flash and or other mechanical light source.

Alternative embodiments include methods and systems to create test ratio labels wherein reference photos are defocused or color averaged and then recomposed using the new calculated color as a texture map back onto the original photo.

Alternative embodiments include methods and systems to compare measured ratios of subject organic products with ratios of test ratio labels, using relative ratio techniques that include the functions of r/b, r/g, g/b, or other combinations of subtraction and division or multiplication

### BRIEF DESCRIPTION OF THE DRAWINGS

FIG. 1 is an upper and lower graph of some of the spectral characteristics of plants compared to light frequencies.

FIG. 2 depicts a spectral curve of a camera flash

FIG. 3 depicts an absorbance curve or spectral characteristics as shown in FIG. 1

FIG. 4 depicts a reflection curve, being an inverted depiction of FIG. 3

FIGS. 5A, 5B and 5C depict various light spectrum curves from a typical camera and registered with the biology curves.

FIG. 6 depicts comparisons of red green and blue channel curves and the relationship to the biology.

FIG. 7 depicts typical smart phone color sensitivities.

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

### BACKGROUND

Spectrometers have been widely utilized for spectral analysis for many years. They typically analyze spectral characteristics in narrow bands over small areas. A prior art or current art shortfall is that most imaging devices, such as a mobile phone or silicon based imaging sensor have filters that prevent effective narrowband analysis to be used in qualitative and qualitative and quantitative analysis.

A video camera or image sensor such as those found in cell phones use wideband filters for color differentiation. A cell phone or smart phone usually measures visible light only and cannot provide spectral bands quantification at specific narrow band spectral frequencies without the use of lens filters or removal of Bayer or IR filters. The output of these cameras is compromised by including various proportions of red, green and blue channel sum values that are not congruent to pure red 600 to 700 nm, pure green 500 to 600 nm or pure blue 400 to 500 nm with a consistent sensitivity. The solution is complex as the spectral properties of both organic and inorganic objects have their own independent spectral responses that also can include a mixture of narrow band responses in the red, green and blue channel values.

In addition, the color sensor itself does not accurately measure pure RGB colors due to variances in the sensitivity to signal intensity. For example, camera blue can range from 400 to 580 nm, camera green can range from 450 to 620 nm while camera red can range from 520 to 700 nm and is compromised further by varying sensitivities across the spectral bands. Thus, spectral analysis in specific ranges becomes problematic.

Disclosed embodiments overcome these prior art shortfalls by:

Exclusive use of wide band RGB outputs and their relative ratios and calculated relationships rather than absolute values.

Use of a single or multiple flashes with known spectral properties and intensities and time delayed image capture.

Use of auxiliary lighting with specific narrowband spectral properties.

Use of image processing including subtractive techniques.

Exploiting unique spectral responses of multiple objects in the field of view.

Using relative channel values of multiple objects in a field of view.

Using comparisons to known measured characteristics.

Use of measurement of thermal and fluorescence responses to light.

To overcome the prior art shortfalls mentioned above, the biological analysis may be ascertained by use and manipulation of a wideband digital output and accepting relative values as solutions rather than absolute values. Since physical objects have their own specific spectral properties in addition to the sensor/camera properties, true absolute wideband spectral channel summary values may be deduced or inferred by exploitation of the known properties and the relative changes in the sensor wide band channel summaries that are compared in multiple images, or objects in a single picture or by the use of auxiliary lighting and other image processing techniques.

By the artful extraction of wideband spectral channel summary information as described herein, color label areas incorporating channel wideband spectral channel summary ratios of products may be imaged and compared with the ratios of an adjacent ratio label.

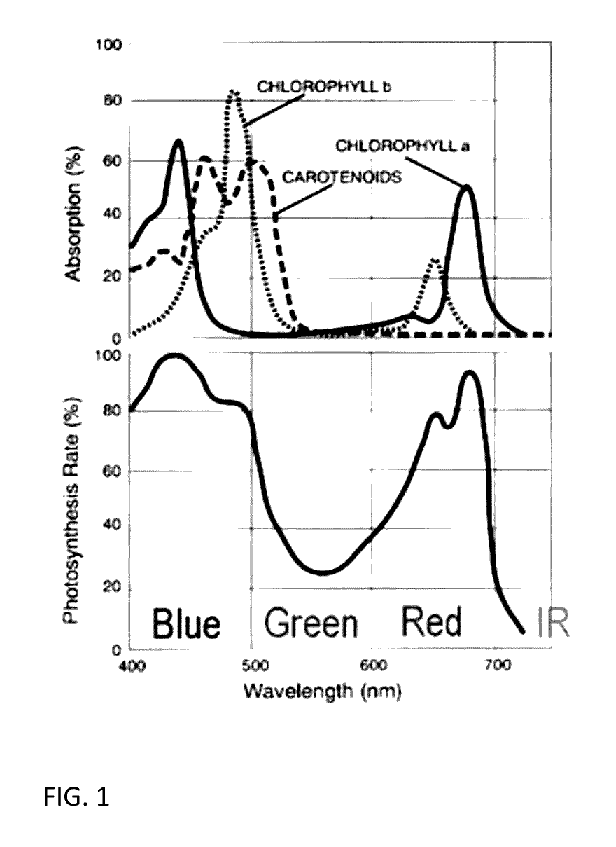

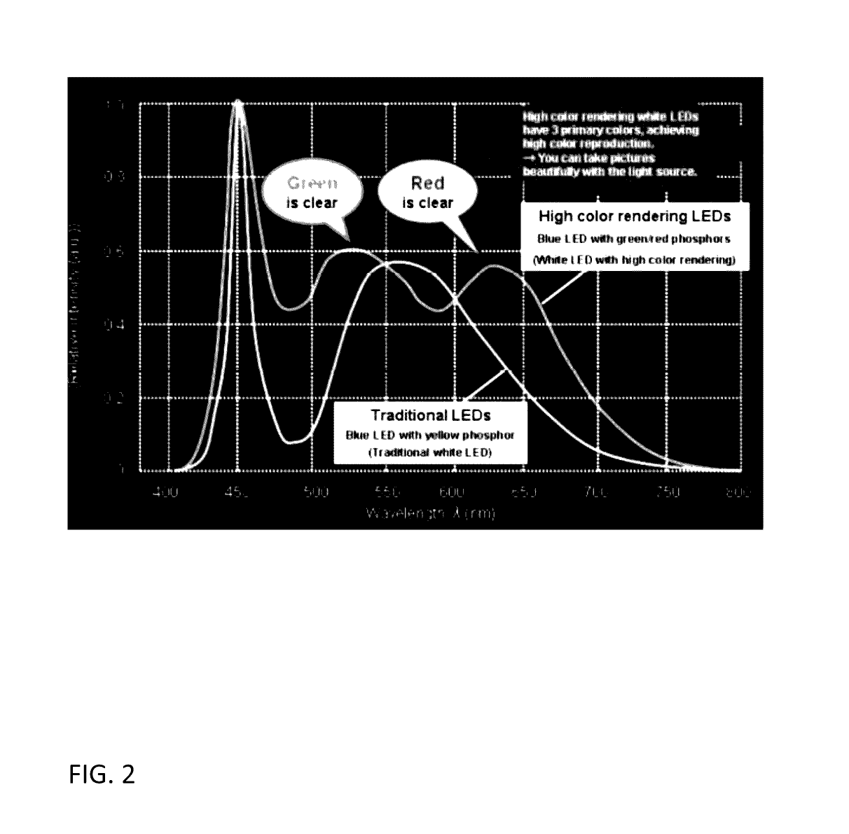

Referring to FIG. 1, in an upper graph, spectral characters of plants are plotted over a lower graph comprising a combined spectral curve wherein green is purely 500 to 600 nm, pure red is 600 to 700 nm and pure blue is 400 to 500 nm

The true blue (400 to 500 nm) range includes response to chlorophyll a, chlorophyll b and carotenoids. The amount of chlorophyll photosynthesis is indicative of plant health, so the ratios, as used herein, between pure green, red and blue, are indicative of plant health. Such ratios and/or total values derived from wideband sensors are therefor also indicative of the relative health of multiple plants in a picture if the analysis is based on the transformed formulas that consider sensor wideband sensitivities across multiple bands and known plant color responses. The disclosed embodiments include the use of such systems and methods to obtain color ratios.

In a disclosed embodiment, a single organic product is displayed with pixels depicting different calculated relationships than other products in the same picture. To implement this embodiment using consumer smart phones and other devices burdened with Bayer and/or IR filters, various challenges must be overcome and are as described herein. One such challenge is true RGB separation, which is adversely impacted by use of Bayer and IR filters. The lack of true RGB separation may be called an ambiguity. An embodiment herein resolves the ambiguity by a new system of and use of auxiliary lighting and image processing and acceptance in some instances of relative values or ratios as a solution rather than ambiguous absolute values. Here again, the disclosed systems find ratios of a subject organic product.

In one disclosed embodiment, problems of the prior art are solved by use of making relative comparisons of multiple objects in a single image or from two or more separate images. In another embodiment, the use of auxiliary lighting and image processing as described herein will assist in resolving ambiguities. In one example, the ambiguity is resolved by 1) using auxiliary light, such as a camera flash having known light frequencies and intensities over one or more flashes or an LED with known narrow band light emission characteristics and 2) application of image processing techniques and 3) known or predicted biologic relationships that relate to spectral measurements in wide bands. Two or more images can be taken in rapid succession with and without the auxiliary light and or with different intensities and image processed. This technique can also be used to compensate for ambiguities from ambient light.

This disclosed system overcomes the prior art shortfalls which use spectroscopy with specific narrowband wavelengths. Disclosed embodiments overcome such prior art and shortfalls by a relative value approach which uses wide band comparisons of wideband spectral channel summaries as derived from typical consumer smart phones with image sensors that are burdened with Bayer and IR filters.

An indicator of many organic subjects' age is the ratios of chlorophyll b to carotenoids. As a fruit or vegetable ages, chlorophyll b levels usually go down modestly and carotenoids increase more rapidly. Thus, as used herein, the ratio of carotenoids to chlorophyll validly reports relative biologic age. Ripeness can be rated by the ratios of green to red or green to blue depending upon the vegetable variety and its end stage anthocyanin color. A tomato for example, as it ripens changes from green to red. Blue generally increases a small amount as a vegetable ages and red reflection increases at a greater rate as the absorption of red decreases with time. Therefore green blue ratios or red blue channel ratios also can also characterize age. In such an example a ratio label may comprise various green blue and red ratios to map product age.

Another technique is the measurement of fluorescence. Certain vegetables such as kale or broccoli will emit light as a result of the organic photosynthetic chemistry when subjected to a pulse of bright light such as a flash from a camera or cell phone. These emissions can be measured in the wideband channels and are indicative of the vegetable's photosynthetic activity chemistry. Other vegetables, such as red potatoes have unique chemistries with their own color qualities and aging properties related to carotenoids and anthocyanins changes. What is important is the relative wideband comparisons or ratios of green red blue channel relationships and ratios.

There are specific ratios in the pure spectral red green and blue spectra as seen in FIG. 1. In the example of agriculture, the ratio of chlorophyll b contributing to the entire broad band of the red channel when compared to the contribution of chlorophyll b in the broad band blue channel is a constant. See FIG. 1 as well for the effects and ratios of chlorophyll b and carotenoids in the pure RGB bands.

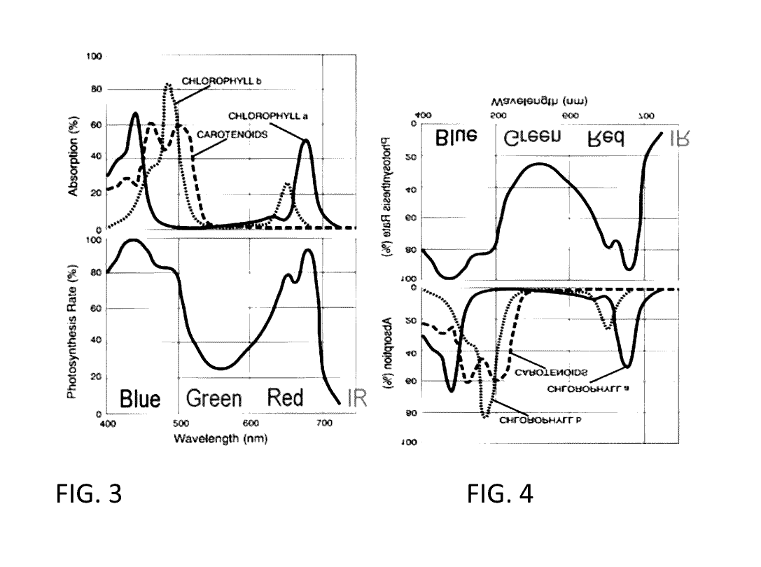

FIG. 3 is an absorbance curve, while FIG. 4 is a corresponding reflection curve, FIG. 4 being an inverted representation of FIG. 3.

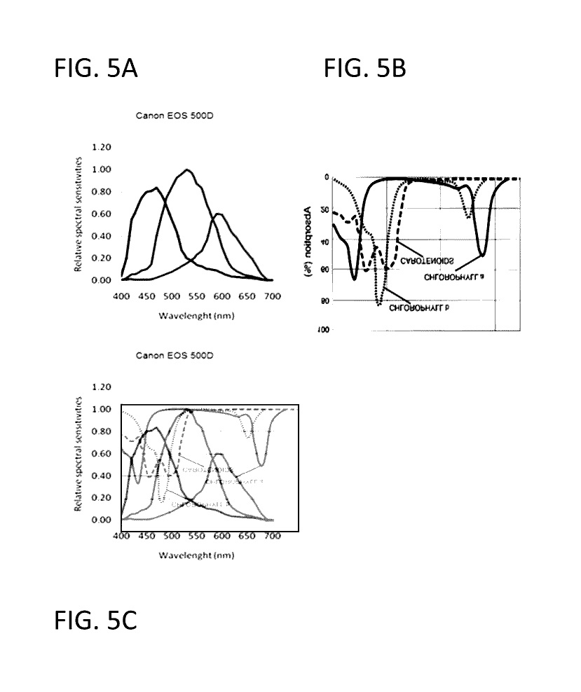

FIGS. 5A, 5B and 5C assist in an interpretation showing in FIG. 5A a spectrum of a camera burdened with a Bayer filter curve, FIG. 5B, a reflection curve and 5C, a representation of FIG. 5A transposed onto FIG. 5B.

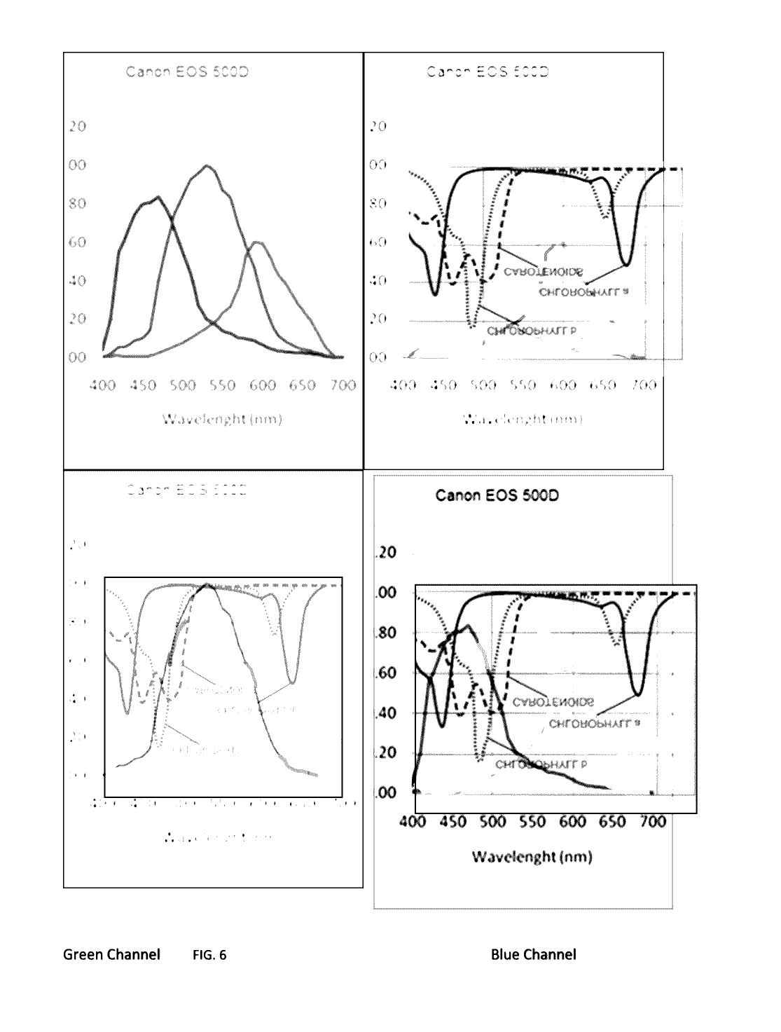

FIG. 6 presents individual channels. The comparison or analysis conveys an understanding of the spectral relationships and how a cell phone will respond. For example, in the red channel, changes in chlorophyll a will have some impact in the red channel but a larger impact in the blue channel. Chlorophyll b changes results in a relatively modest impact in the green channel, with a larger impact in the blue and red channels. Carotenoids have a bigger impact in the green channel and blue channels. So subtraction of the red minus green channels will be somewhat related to the value of the carotenoids. Relative values or ratios of chlorophyll a, chlorophyll b and carotenoids can be inferred by a comparison of the areas under the sensor curves for each component broad wavebands using relative simultaneous equations that can infer relative values or ratios, but not absolute values in many instances.

As illustrated and/or inferred, the blue channel will be sensitive to changes in chlorophyll a and b and carotenoids. The green channel will be most sensitive to carotenoids and chlorophyll b changes and the red channel will be most impacted by chlorophyll b and less by chlorophyll a. Therefore there are three variables and three simultaneous equations can be solved with only ratios between the values. Specific absolute values can then be inferred if there is knowledge of the light source intensities. approximated by using measured light values from the camera's automatic light meter, exposure times, or IR distance detector if available. These relative ratios can be further resolved by using the known distance from lens to the object and measuring the total amount of reflected light to the lens. Distances from the subject to be analyzed to the lens which can be identified by the focus distance reported from the auto focus feature of a cell phone or video lens or IR distance detector.

By creating look up tables for the unique Bayer filter curves for a specific cell phone or video camera, the values of the chlorophylls and carotenoids can be inferred. In a single picture with multiple fruit, qualitative values can also be easily displayed by comparison of the relative values to established curves empirically determined. Disclosed embodiments overcome shortfalls in the art by replacing look up tables with predetermined ratio labels. The ratio labels are placed near a relevant subject organic product, thus mitigating the memory storage requirement of a look up table.

For plants, the changes in the relative ratios of wideband spectral channel sums taken over time can determine health status by noting changes in wideband ratios and relationships.

Measuring and comparing the relative ratios of the channel information such as r/g, b/g and or r/b to can be used to assess the relative health of a plant. Derivative formulas can also be used such as differences between wideband spectral cannel summary channels, or common arithmetic expressions such as square or log or subtraction or combinations. (R-b)/b, (R-G)/B, (r-b/g-b) are examples where the blue value using a flash will auto correct for light intensity variances that utilizes the blue channel for compensation for variations in light intensities.

In general blue reflected light tends to remain the same and gradually increase as a plant or vegetable ages, green absorbance varies and red varies according to the actual photosynthesis occurring that is absorbing red light.

Calibration in the methods described in these claims for weighted color coefficients can be based on the desired spectral characteristics of the object to be measured rather than the color characteristics of the imaging sensor against a standard neutral background. This will modify the wideband spectral cannel summary coefficients to maximize the deltas in the derivative formulas. A typical spinach leaf will have a different g/b or r/b ratio that a Brussel sprout. The coefficients would be calibrated to visualize the maximum variance in the ratios.

Further Shortfalls in the Prior Art

Researchers have used specific spectral lines to characterize vegetables. Unfortunately, these analytic procedures cannot be generally done on a cell phone due to the required narrow wavelengths. By using the relative wideband spectral channel summary channel values of a cell phone, and their relative values biologic characterizations can be inferred.

Examples of WideBand Transformations

An example is Peñuelas et al., 1994 Rodríguez-Pérez et al., 2007

NPCI=(R680−R430)/(R680+R430)

normalized pigment chlorophyll ratio index

Note the specificity of the selected nm wavelengths

This translates to

Carotenoid/chlorophyll a+b and translates in general to wideband

(R−B)/(R+B)

Or to determine the pigment chlorophyll index using a cell phone where X,Y,Z are weighted coefficients determined by the individual cell phone spectral response curves or generalized spectral response from the object for each of red, blue, green widebands.

X*(Red Channel)−Z*(Blue Channel)/X*(Red Channel)+Z*(Blue Channel)

Another example is

PSRI=Merzlyak et al., 1999

(R680−R500)/R750 translates to wideband (red−green)

Plant senescence reflectance index

X*(Red Channel)−Y*(Green Channel) and since we only need relative values, the infrared R750 need not be considered.

Narrow Band Light

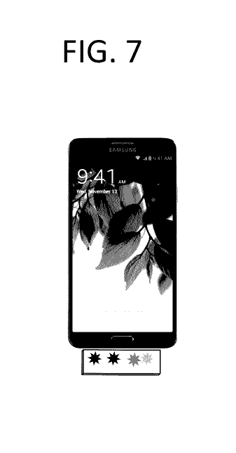

FIG. 7 depicts a typical smart phone with a cube that can plug in to the USB or audio ports of the smart phone or similar device. The cube or other ancillary may have narrow band LEDs controlled by the device to flash light in sync with the camera shutter.

By using narrow band lighting, such as led or laser light sources, image subtraction processing and using relative and not absolute values, many narrow band tests can be done in wide bands. It is not an absolute method, but in this instance using relative values or ratios will produce the desired relative results.

An example of a transformation where narrow band auxiliary light could be useful is Gitelson-Car1 [R(510-520)-1-R(540-560)-1] [symbol] R(760-800) Gitelson et al. (2003, 2006)

In this instance narrow band light at 510 and 520 can be used with wide band green. The transformation is (Y2*G510-Y2*G520)-1-Y1*G-1) with the remaining variable R(760-800) considered a constant. The relative value is the objective not the absolute. Y2 is a weighted coefficient for the auxiliary light

For plants, adding auxiliary narrowband lighting at the peaks of the curves yields more accurate results. For example, Chlorophyll a=430 and 665 nm narrow bands; chlorophyll b=410, 470, 647 nm. The ambient light curves would be subtracted from the curves taken with the narrow band auxiliary light. In this instance, the wideband spectral cannel summary efficiencies at these wavelengths would also need to be considered.

The specific photosynthetic analysis can also be used to control water, light or fertilization systems that respond to a plant's photosynthetic state that do not require a graphic display of the information.

Water stress, nitrogen levels and disease detection can also be monitored by wideband spectral channel summary analysis.

Process and Method Description

In general, the first step is to take a picture with ambient light (A) and auxiliary light that can be from an external light such as a flash or narrow band led or from a cell phone display screen itself.

Disclosed embodiments include a process to capture wideband spectral channel summary data and present the subject object in an augmented view to highlight relevant attributes such as channel ratios. The process may include:

1. Capture wideband spectral cannel summary data or the image.

2. Calibrate the weighted wideband spectral cannel summary coefficients to normalize the wideband spectral cannel summary values. In this instance, red=1, green=5 and blue=4. The specific ratios can be determined by normalizing the predominant color of the item to be measured to a fixed variable. For example, red in the instance of a red tomato, is normalized to one or the green value is normalized to one in the instance of green vegetables to determine the coefficients where R×R(c)=B×B(c)=G×G (c) where (c) is the coefficient and R G or B are the output values. Alternatively all values can be balanced to white, however, normalized to the dominant color or coefficient determined by the object to be analyzed may produce greater differentiation.

3. Select desired characteristic such as senescence and formula or ratio.

In this instance camera blue/camera green or camera red and apply to all items in the picture using the normalizing coefficients from step 2.

4. The program will perform a specific transformation of the image such as a ratio of camera green/camera blue for every pixel. A calibration step (coefficient) for each of the wideband spectral cannel summary channels is applied information applied the camera output to maximize the scale of differentiation of the ratios. For example 5× Green value/4× blue value.

5. Display the image with the calculated pixels using a grey scale or colorized ranges.

An additional display technique is to divide an original image into RGB or other component technique and grey scale ranges.

Then recombine the image substituting the calculated grey scale for the original grey scale.

Other combined images can be done using one or more color picture components from the original picture that is substituted with the calculated image.

### Alternative Embodiments

The image sensor can be one or more pixels with two or more data points. The output data points can be over time or over different lighting conditions. A memory unit is required for comparison of data points taken over time.

The method and use of an image sensor in a mobile phone or other imaging device or pixel array to determine qualitative relative characterization based on both the spectral characteristics of the image sensor and or an object's or multiple objects' physical properties to be measured.

The method above using one or more pictures or data points with or without flash or other auxiliary lighting with known spectral characteristics and or and subtractive image processing techniques. Broad band output ratios or other wideband spectral channel summary formulas can be used to infer qualitative and quantitative assessments.

The relative comparison of spectral qualities or ratios of organic or inorganic objects utilizing the broad spectral responses of a mobile phone, camera or other sensor compromised by a Bayer or other color filter to characterize a relative quality by quantifying one or more of the spectral wideband spectral channel summary outputs of a imaging device and or relative ratios of objects within a frame and calculating the desired parameter that utilize a known spectral characteristic or response to light of the object to be measured. These known spectral responses can include characteristics of, fluorescence, absorption, light saturation and reflection in specific spectral bands.

Determination of relative spectral properties of multiple objects in a single image by comparison of their measured wideband spectral channel wideband spectral cannel summary ratio values of the device. An image is acquired by the device. Then a specific ratio or formula is selected corresponding to the desired characterization. The full image is processed according to the formula. The relative ratios or formula outcome are used to modify the image to provide the characterization through shading, color, outlining or other form of object segmentation.

The method above where is single object is characterized by comparison to a previously acquired data set or image.

The method above where subtraction or image processing techniques that utilize known auxiliary light source spectra to enhance the fidelity of the wideband spectral channel wideband spectral cannel summary data.

The use of two or more images to acquire the relative wideband spectral cannel summary values by using image processing techniques that consider differences of images with or without auxiliary light with known spectral characteristics or

Additional lighting provided by spectral filters placed over on device light or from the display side of a mobile device and using the selfie (front) imaging sensor.

Combinations of the Above

Taken at different times, for example before and after a saturating light source sequence flashes.

Assessing organic characteristics of individual objects by measuring the relative spectral characteristics that change by the amount of light and time of illumination and quality of light interacting with the organic or inorganic chemicals of the object with known standards. The measurement of the ratios between wideband spectral channel outputs can be used to indicate the health of the plant related to environmental requirements such as light, hydration fertilization. Additionally health conditions such as the optimal wideband spectral cannel summary ratios can be identified for a specific cell phone and adverse problems such as insects, root rot, bacteria, virus or other pathogens can be discovered.

In the instances where absolute quantitative results cannot be calculated, relative comparative qualitative analysis of the object or objects can be determined by comparison to other objects in the image or by comparison to multiple images or data points from a single pixel taken over time under different lighting, time or temperature variables. A thermal temperature sensor can be added to better characterize the results. For example, under the condition of light saturation for photosynthesis, the heat conversion of light coefficients will increase.

The use of this data to control other devises such as power or digital control signals.

This information can be used to control independent devices such as lighting or sorting devices. In particular led lighting can be modulated by frequency or intensity according to a plants absorption of red and or blue light or other wideband spectral cannel summary ratios for example when light saturation has been achieved.

These wideband spectral cannel summary relationships are not limited to biology, but can be also used for color matching, measurements of pollution, can be used with chemicals to produce spectral characteristics for both organic and inorganic spectral measurements. Examples include gems, hair color, surface color matching, pollution, mold and virus detection.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms.

What is claimed is:

1. A method of comparing ratios of wideband spectral channel sum values of an agricultural product that can include but not limited to produce, poultry, fish, meat flowers, plants and crops, to wideband spectral channel summary ratios of a preprinted ratio label, in a manner to highlight calculated biological qualities detected on wideband image sensors, the method comprising the steps of:
a) obtaining one or more broadband digital images of the agricultural product, the digital images containing sensor wide broadband color values that may include red, green and blue channels (RGB) or other separation techniques;
b) creating agricultural wideband spectral channel summary ratios from the wideband RGB values from a plurality of derivative formulas such as r/b, g/b, r/g wherein the ratios relate to both pure biological narrow band properties as well as sensor wideband sensitivity;
c) creating the preprinted ratio label by using wideband spectral channel summary ratios mapped to the calculated biological qualities; and
d) comparing and reporting wideband spectral channel summary ratio differences between the agricultural product's wideband spectral channel summary ratios to the wideband spectral channel summary ratios of the preprinted ratio label.

2. The method of claim 1 wherein a calibration step in the form of a coefficient for each of the RGB channels is applied to further define the agricultural product's wideband spectral channel summary ratios.

3. The method of claim 2 further including the step of calibrating the RGB coefficients to enhance the dynamic range of the wideband spectral channel summary ratios or derived formulas, by either:
i. calibrating to white where all coefficient values are set to equal 1 or constant, or
ii. using the specific ratios of RGB values determined by normalizing the predominate color of the agricultural product, if Red is the predominate color of the agricultural product, R×R(_{c})=B×B(_{c})=G×G(_{c}) wherein (_{c}) are the coefficients and R, G and B are measured values by the image sensor.

4. A system for capturing one or more images of an agricultural product and for producing an agricultural product's wideband spectral channel summary ratios, the agricultural product's wideband spectral channel summary ratios reflecting relative quantities of calculated biological characteristics, the system also creating a preprinted ratio label having wideband spectral channel summary ratios, and comparing the agricultural product's wideband spectral channel summary ratios to the wideband spectral channel summary ratios of the preprinted ratio label, the system comprising:
a) an image acquisition device comprising an image sensor connected to an image processor to acquire an image of the agricultural product;
b) the image processor configured to obtain, output and record broadband spectral data for individual wideband RGB channels obtained from the image of the agricultural product and configured to produce the agricultural product's wideband spectral channel summary ratios;
c) the printing of the preprinted ratio label by use of wideband spectral channel summary ratios mapped to the calculated biological characteristics or derived from archived data tables;
d) the image processor further configured to compare the agricultural wideband spectral channel summary ratios of the product to the wideband spectral channel summary ratios of the preprinted ratio label.

5. The system of claim 4 wherein the system includes a display screen to report the comparison of the agricultural product's wideband spectral channel summary ratios to the wideband spectral channel summary ratios of the preprinted ratio label.

6. The system of claim 5 wherein the image processor is further configured to obtain the relative spectral properties of the agricultural product by use of the agricultural product's wideband spectral channel summary ratios in comparison to the wideband spectral channel summary ratios of the preprinted ratio label.

7. The system of claim 4 wherein the image processor is configured to produce the agricultural product's wideband spectral channel summary ratios by:
i. measurement of relative spectral characteristics that change as a function of the amount of auxiliary light detected; and/or
ii. time of illumination and intensity of light interacting with either the organic or inorganic chemistry of the agricultural product.

8. The system of claim 4 wherein the image processer is configured to accept input from a thermal measurement device and use the input to further refine the wideband spectral channel summary ratios of the agricultural product.

9. The system of claim 4 wherein the image processor is configured for production of wideband spectral channel summary ratios of both organic and inorganic objects that include, gems, hair color, skin color, tissue color, cosmetics, surface color matching, pollution, mold and viruses.

10. The system of claim 4 including a flash, LED, laser, cell phone display or other light sources and filters with known spectral properties synchronized to the image acquisition device.

11. A method of measuring and comparing the relative ratios of wideband R, G and B in an agricultural product with wideband spectral channel summary ratios of a preprinted RGB ratio label to characterize the relative health of an agricultural product, the method comprising:
a) obtain an image of the agricultural product;
b) separating color components and measure each pixel into their respective wideband color components;
c) selecting a formula that relates to effects of biological characteristics on narrow bands and transforming the formulas for broad band results to comport with broad band functions;
d) apply the selected formula to the color components to create wideband spectral channel summary ratios of the agricultural product; and
e) compare and report the comparison between the wideband spectral channel summary ratios of the agricultural product and the wideband spectral channel summary ratios of the preprinted RGB ratio label.

12. The method of claim 11 using auxiliary lighting to obtain a second image of the agricultural product and then, using the original image, subtracting the ambient lighting from the second image to derive a third image that characterizes wideband spectral channel summary ratios on the basis of the spectral qualities of the auxiliary lighting and using wideband spectral channel summary ratios of the third image to compare with the wideband spectral channel summary ratios of the preprinted RGB ratio label.

13. The method of claim 11 including the steps of calibrating color components to white or calibrating to the dominant color of the agricultural product to derive RGB coefficients that relate to derived formulas and the specific fruit.
